(19) United States
(12) Patent Application Publication
(10) Pub. No.: US 2008/0028894 A1
(43) Pub. Date: Feb. 7, 2008

(54) Ratchet Wrench

(76) Inventor: Jean-Claudee Maret, Chilly-Mazarin (FR)

Correspondence Address: OLIFF & BERRIDGE, PLC, P.O. BOX 320850, ALEXANDRIA, VA, 22320-4850, US

(21) Appl. No.: 11/791,472

(22) PCT Filed: May 9, 2006
(86) PCT No.: PCT/FR06/01026

§ 371 Date: May 24, 2007

(30) Foreign Application Priority Data
May 9, 2005 (FR) 0504629

(51) Int. Cl. B25B 13/46

(52) U.S. Cl. 81/60

(57) ABSTRACT

A ratchet wrench with interchangeable sockets is of the type incorporating an elongated casing formed of two half-shells in which a hub is positioned inside which slide a finger, a ratchet and an assembly of front, median and rear toothed wheels and their associated toothed pinions and a rack. The wrench includes, in addition, a slide arranged longitudinally in the casing meshing onto the rear wheel by the rack to drive the rear wheel in rotation and a pusher protruding from the casing linked to the slide to drive the slide in translation. The device ensures a first tilting of the rack onto the rear wheel and a second tilting of this rack to release the rear wheel.

The technical scope of the present invention is that of tools for hand screwing and unscrewing such as ratchet wrenches with interchangeable sockets or screwdrivers used in general mechanics.

At present, ratchet wrenches enable screws, or nuts if the latter are braked, to be driven. If the screw or nut is free, this type of wrench does not work. The user is obliged to brake the head with the other hand thereby implying manipulation with both hands. In any event, the operation is time consuming and requires many to and fro movements.

Ratchet wrenches with fast socket drive have already been proposed, but these proposals are neither compact nor easy to use. Either the wrench is in the form of cumbersome pliers, or in that of a rotating handle which is impractical to use.

Patent FR-A-03.05020 has tried to propose an improvement by proving a pusher fitted with a rack able to act on a wheel. However, the user must activate this pusher in translation perpendicularly to the wrench body described in this patent. Moreover, this pusher is located in the middle of the tool and the drive rack is transversal. Because of this, the wrench body is very wide and the ratchet can only be used when the push button is depressed. There is no safety system provided to protect against use at high torque. This wrench is thus uncomfortable to use, all the more in that there is little amplitude in the rotation of the screw.

The aim of the present invention is to supply a ratchet wrench or screwdriver which is both easy to use and provided with a safety device.

The invention thus relates to a ratchet wrench with interchangeable sockets of the type incorporating an elongated casing formed of two half-shells in which a hub is positioned inside which slide a finger, a ratchet and an assembly of front, median and rear toothed wheels and their associated toothed pinions and a rack, wherein it comprises, in addition, a slide arranged longitudinally in the casing meshing onto the rear wheel by means of the rack to drive it in rotation and a pusher protruding from the casing linked to the slide to drive it in translation, means being provided to ensure a first tilting of the rack onto the rear wheel and a second tilting of this rack to release the rear wheel.

According to one characteristic of the invention, the pusher is activated in rotation and the slide is provided with an inclined slot in which a finger of the pusher is engaged so as to transform the rotational movement of the pusher into a translational movement of the slide.

According to another characteristic of the invention, the slide is held in the casing by a first roller and a second roller, the slide being provided with a first longitudinal slot in which the first roller is engaged in order to enable only a translational movement of the slide, and a second slot in which the second roller is engaged to enable a translational and rotational movement of the slide, the rollers and the slots providing means of tilting of the rack.

According to another characteristic of the invention, the second slot has a width greater than the diameter of the second roller so as to ensure by rotation in the rear position the meshing of the slide rack on the toothed wheel and in the forward position the release of this wheel.

According to another characteristic of the invention, a spring is positioned between the second roller and an edge of the second slot.

According to another characteristic of the invention, the finger is able to move in the hub between two extreme positions limited by a pin integral with the hub and sliding in a slot in the finger.

According to another characteristic of the invention, the wrench incorporates two means to lock the finger in its two extreme positions, first means to lock the finger in the hub and another means to lock the finger in the interchangeable sockets.

According to another characteristic of the invention, the pusher is in the form of a pin hinged with respect to the casing at its tip, one internal branch cooperating with the slide and the other protruding from the casing, the two branches being joined by a spring.

According to another characteristic of the invention, the hub ratchet meshes on its pawl positioned pressing on a hinge pin integral with the body, the pawl being held in its active position by a spring.

According to another characteristic of the invention, the hub pawl presses on a pin integral with a sliding part connected to a spring so as to ensure the release of the pawl.

According to another characteristic of the invention, the rear wheel is mounted able to slide in the casing and is subjected to the action of a spring in order to uncouple said wheel of the rear pinion whilst continuing to drive the rack.

According to another characteristic of the invention, the pusher and slide are connected together by a connecting rod.

According to another characteristic of the invention, the ratchet and the toothed wheel of the hub are represented by single toothing, such toothing being inclined so as to ensure both driving in rotation by the front wheel and immobilising by the pawl.

According to another characteristic of the invention, the pawl is mounted able to slide on a track integrated in the body.

A first advantage of the invention lies in the fact that the push button enables the rapid rotation of the low torque socket and a slow rotation at high torque with the pawl. Screwing or unscrewing is thus performed rapidly with the push button and locking and unlocking using the pawl.

Another advantage of the invention lies in the use of the tool with only one hand, the other hand being free to provide support.

Yet another advantage of the invention lies in the substantial gain in time and in the reduction in fatigue for the user.

Yet another advantage of the invention lies in the possible use of an oblong casing, both very compact and thin, whose fast drive push button is located in the gripping zone at the tip of the handgrip. The zone which enables tightening pressure to be exerted is located on one side and the push button on the other. The wrench may be used either as a normal ratchet wrench for tightening or loosening, with the push button depressed or not. The fast drive function is performed simply by the fingers on the push button without the necessity of changing the handling position. As soon as the load exceeds that permissible for fast rotation, the user naturally adopts the tightening by ratchet method. The total screwing/tightening or loosening/unscrewing operation time may be substantially reduced. The user may place the screw or nut in the socket and screw and tighten it using a single hand.

The zone where the load is applied may be arranged to provide greater comfort, either by shaping the casing or by adding a plastic or rubberized part. This zone is arranged on the side of the wrench opposite that of the push button.

Because of the dissymmetrical shape of the wrench, the user is immediately aware of the function in place, screwing or unscrewing.

In the wrench according to the invention, safety systems protect the wrench against non-compliant use by using safety systems.

Other characteristics, particulars and advantages of the invention will become more apparent from the description given hereafter by way of illustration and with reference to the drawings, in which:

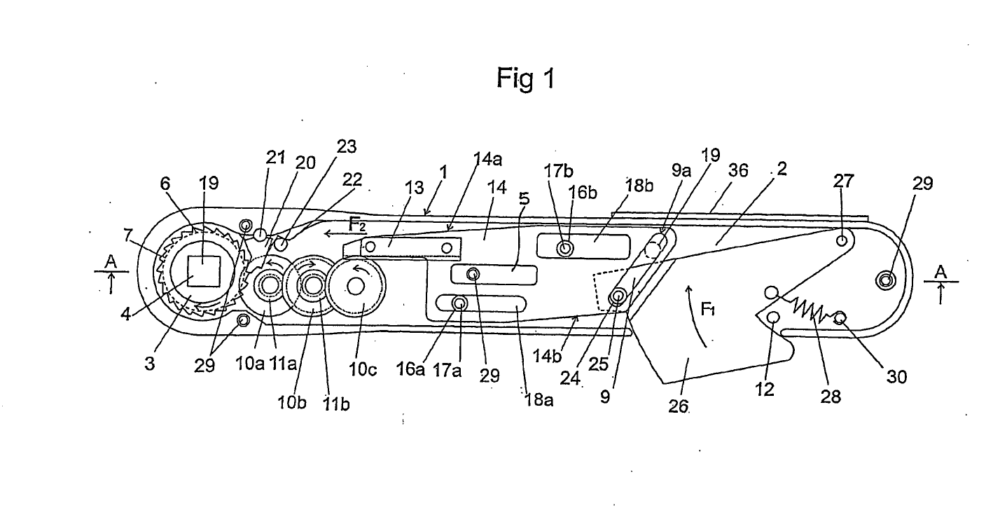

FIG. 1 shows a longitudinal section of the wrench according to the invention,

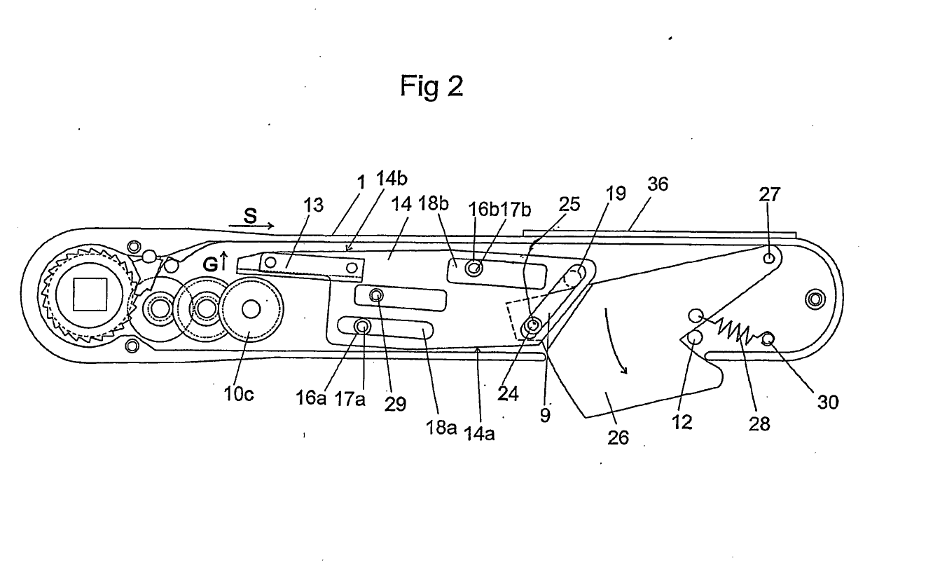

FIG. 2 shows the same section in the disengaged position of the pusher,

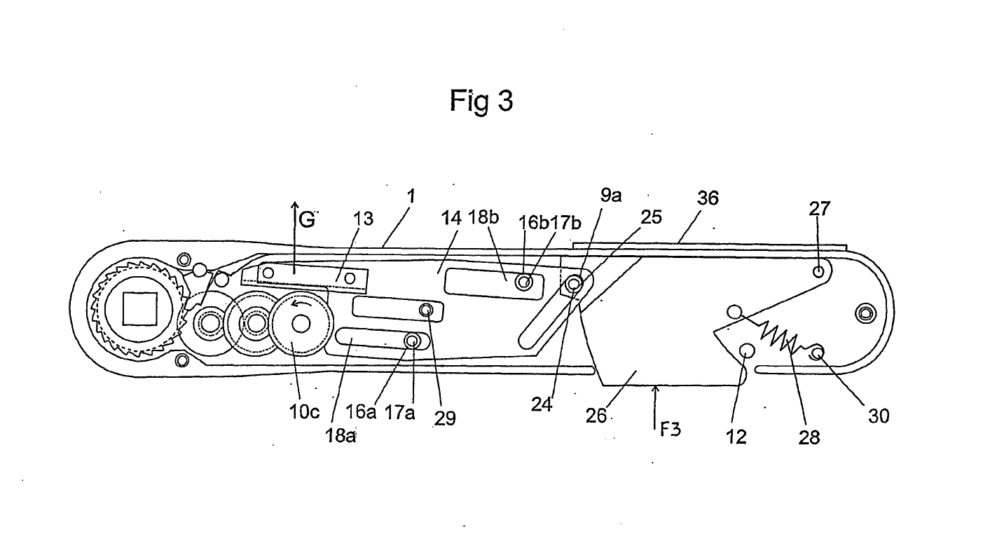

FIG. 3 shows the same section showing the extreme position of the slide,

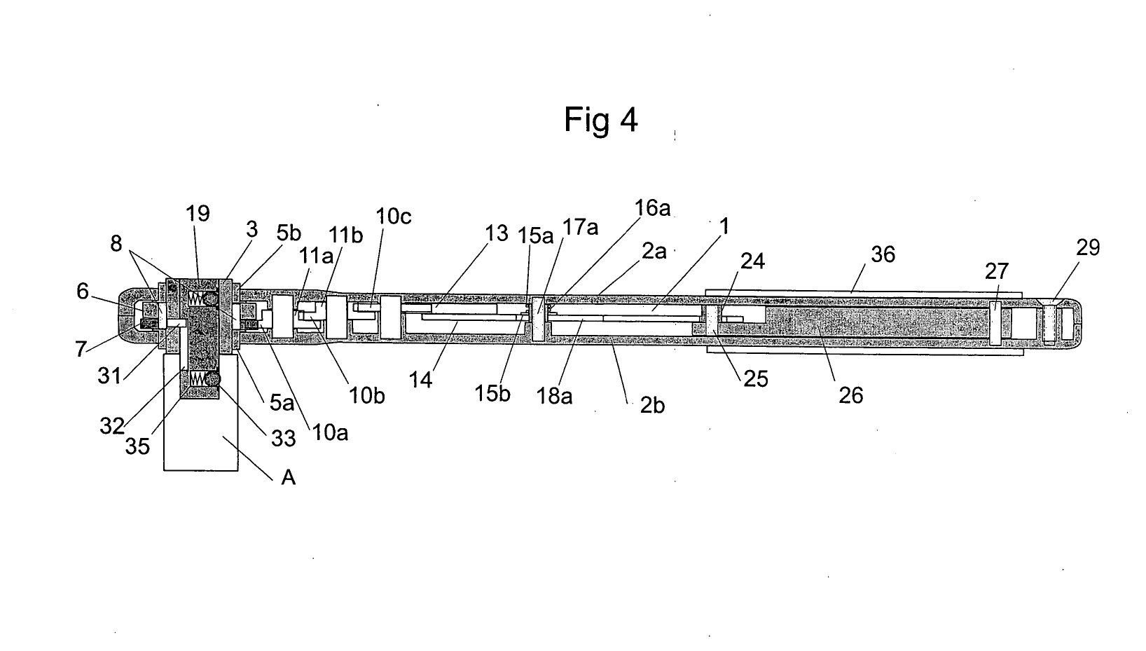

FIG. 4 is an upright section along line AA in FIG. 1,

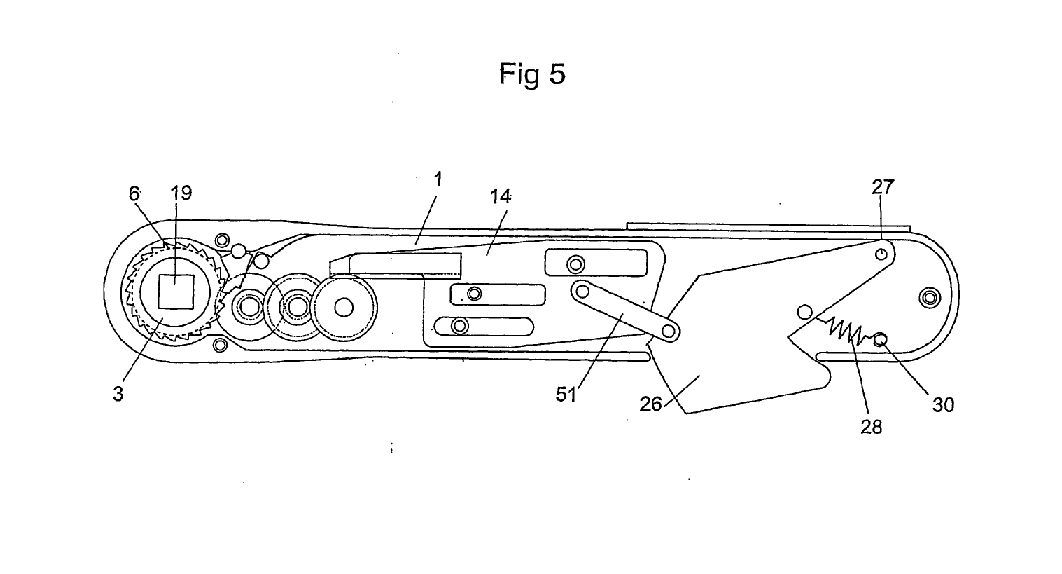

FIG. 5 shows a variant embodiment of the pusher,

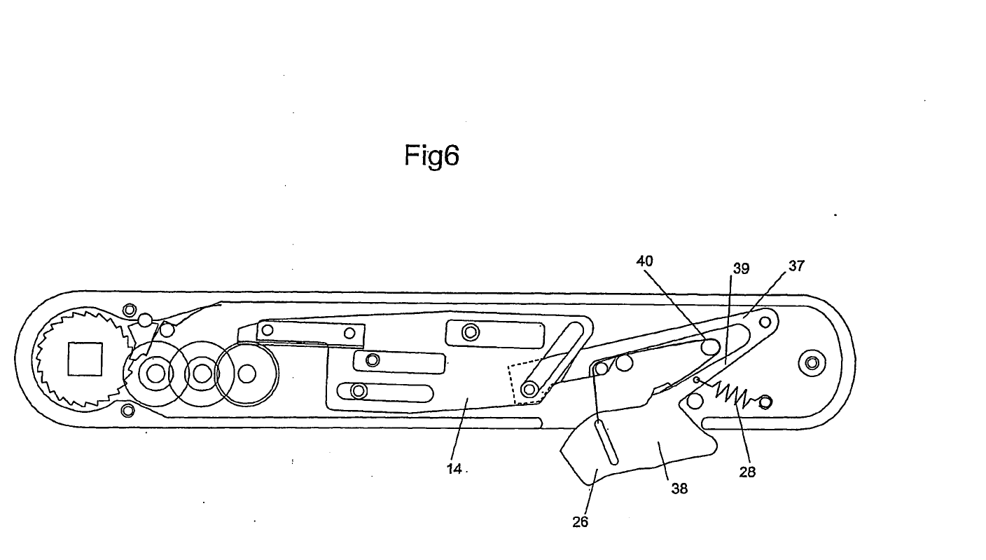

FIG. 6 shows another variant embodiment of the pusher,

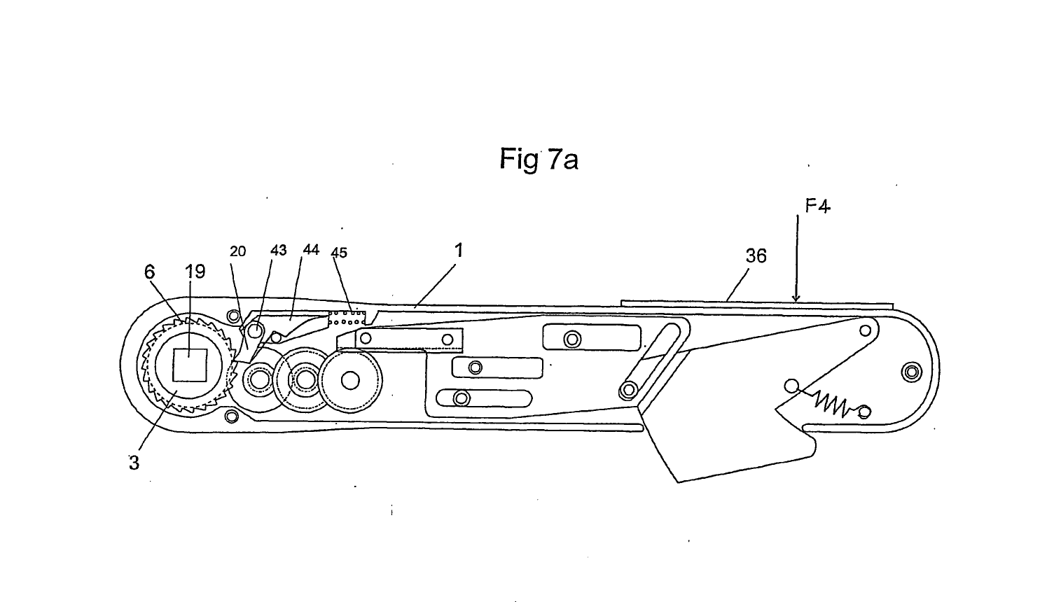

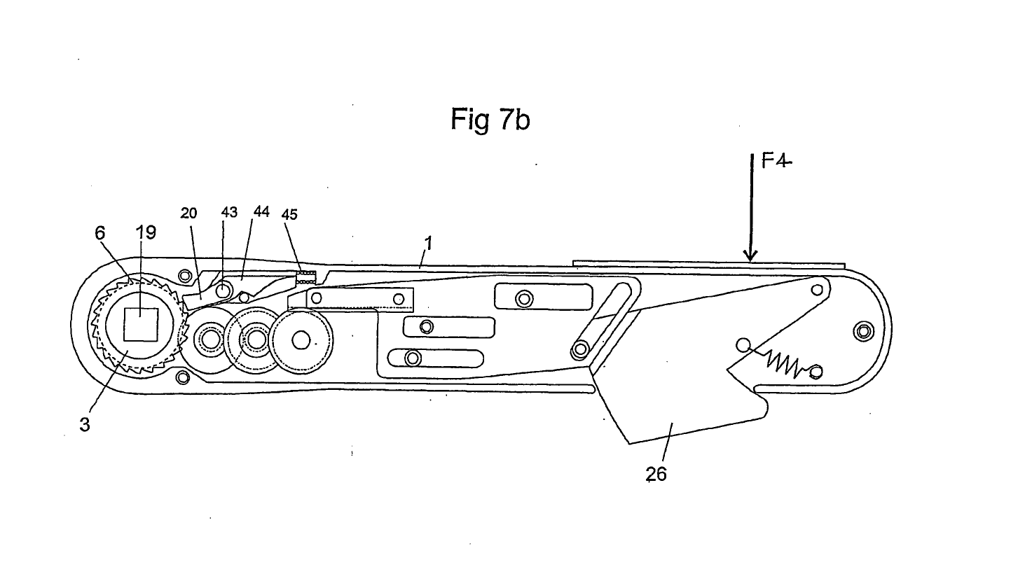

FIGS. 7a and 7b show a particular assembly of the pawl 20,

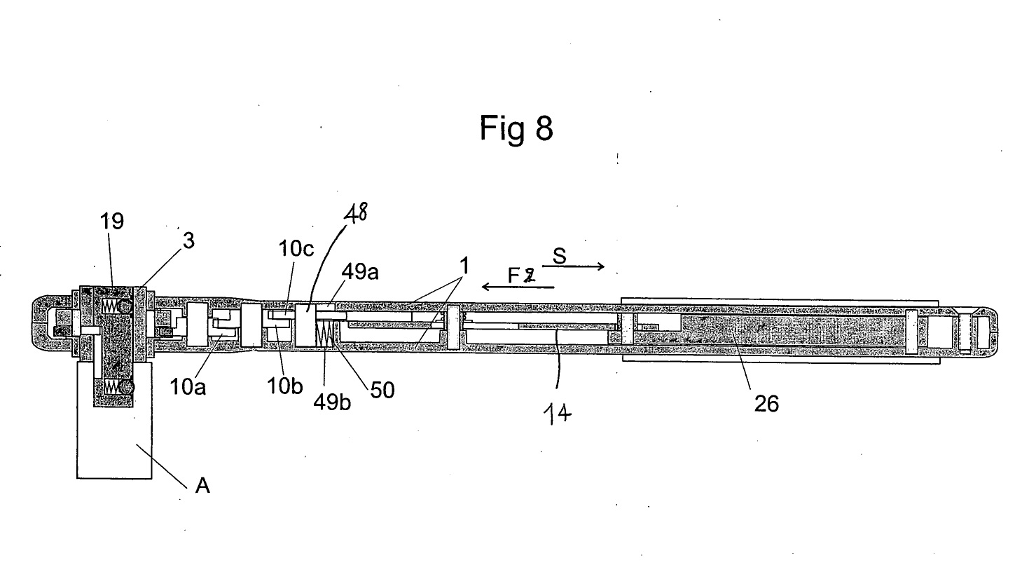

FIG. 8 is an analogous view to that in FIG. 4 showing a particular embodiment of a disengaging wheel,

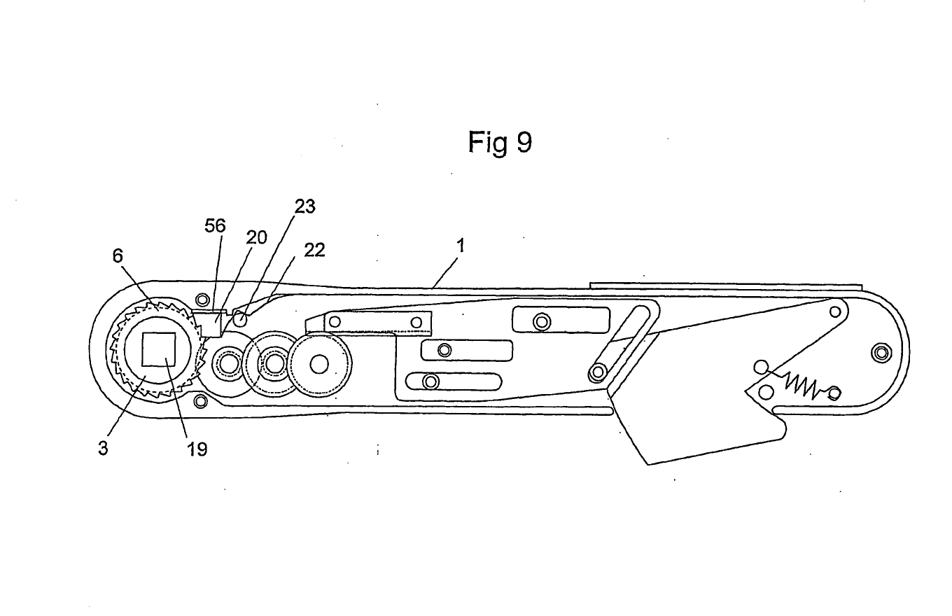

FIG. 9 shows an embodiment of a sliding pawl, and

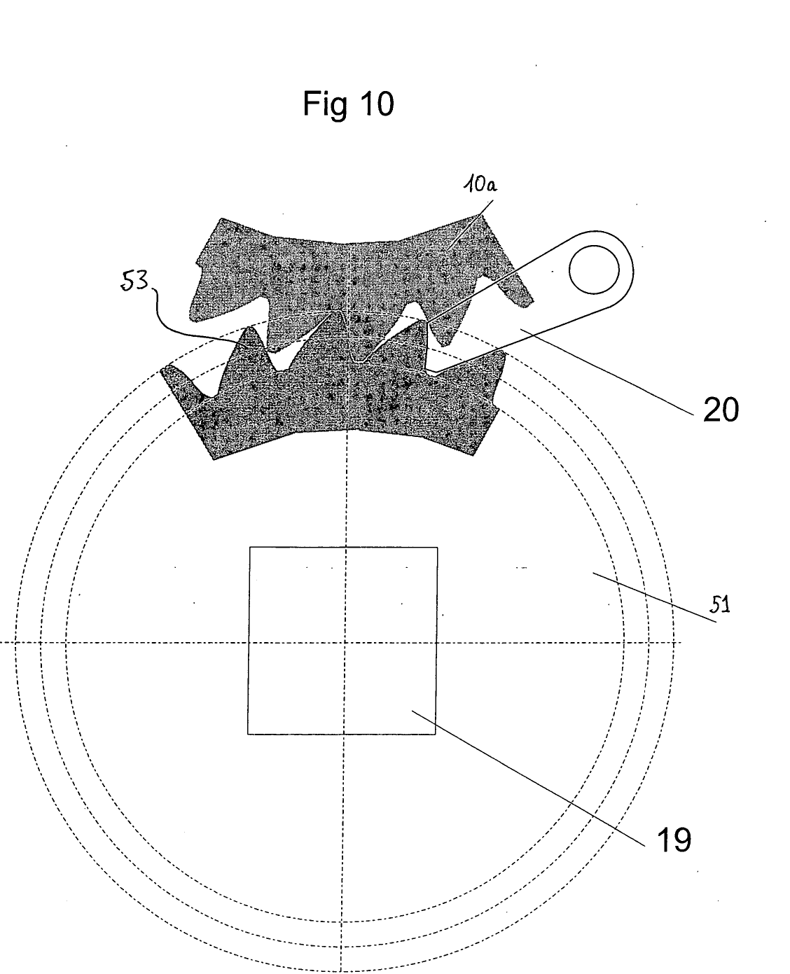

FIG. 10 shows a variant embodiment of the pawl with inclined toothing.

With reference to FIG. 1, we can see that the wrench comprises a casing 1 composed of two half-shells referenced 2a and 2b hereafter in which the whole fast drive mechanism according to the invention is integrated.

Classically, the wrench comprises a hub 3 provided with a polygonal hole 4 in which a finger 19 is inserted and a ratchet 6 which turns between two bushings 5a and 5b which can be seen in FIG. 4. This hub 3 is made integral with a toothed wheel 7 by two pins 8 (FIG. 4). The toothed wheel 7 is driven by wheels 10 (front 10a, median 10b and rear 10c), and pinions 11 (front 11a, median 11b) arranged in a cascade. This wheel and pinion assembly is guided by spindles integral with the casing 1. The ratchet 6 of the hub 3 is immobilised in one rotational direction by a pawl 20 pressing on a spindle 21 and pushed by a spring 22 pressing on a spindle 23 at a distance from the previous one. Lastly, the two half-shells are fixed together by screws or rivets 29 judiciously arranged along their length. Naturally, other fastening means may be implemented such as, for example, bonding or welding. As will be explained hereafter, the finger 19 is able to slide in the hole 4 so as to occupy two positions of use.

From the above description it is understood that when there is low resistance of the screw or nut that needs to be loosened, the wrench 1 must be held in both hands to be maneuvered since the resistance in rotation of the ratchet 6 is too high when the tightening or loosening torque of this screw is low.

So as to overcome this problem, an assembly is provided according to the invention comprising a rack 13 linked to a slide 14 and activated by a pusher 26 whose movement is limited by a limit stop 12. The Figure shows that the slide 14 is in the form of a substantially rectangular elongated plane part provided with a tip to which the rack 13 is attached. The slide 14 is fastened in the casing 2 by means of a spindle 29 fastened to two half-shells. This spindle 29 passes through a slot 5 whose length and width enable both translational and rotational movement of the slide, as will be explained hereafter.

It goes without saying that the rack and tip may constitute a single piece.

The slide 14 incorporates three other rectilinear slots 9, 18a and 18b. Slot 18a receives a spindle 17a carrying a roller 16a whose diameter substantially corresponds to the width of this slot. This results in the roller enabling only longitudinal rotational and translational movements of the slide 14.

The slide 14 is provided with two opposing ramps 14a and 14b so as to enable it to tilt by rotation inside the casing 2. Ramp 14a, the so-called fore ramp, is prolonged at the tip and extends away from the wall of the casing 2. Ramp 14b, the so-called rear ramp, also extends away from the wall of casing 2 but in the opposite direction. Thus, by pressing on roller 16a, the slide 14 is subjected to sufficient rotational movement to disengage the rack 13 from the toothed wheel 10c as will be explained hereafter.

Slot 18b receives a spindle 17b fastened to the casing and provided with a roller 16b. The diameter of the roller 16b is greater than the width of the slot 18b so as to enable both longitudinal and radial rotational and translational movements of the slide 14.

A pusher 26 is arranged substantially in the prolongation of the slide 14 and is fastened to the casing 2 by a spindle 27 and is provided with a return spring 28 attached to a fixed spindle 30. The pusher 26 is connected to the slide 14 in slot 9 by means of a spindle 25 provided with a roller 24. Slot 9 is arranged in an inclined manner so as to cause the slide 14 to be displaced when the pusher 26 is activated following arrow F1 until it reaches a specific position 19 at the bottom 9a of the slot 9.

FIG. 2 shows the pusher 26 in its final active position in which the slide 14 has been subjected to a translation and then a rotation, the rack 13 no longer being meshed with the wheel 10c. The roller 24 of the pusher 26, via its displacement in slot 9, has activated the slide 14 and is now at the other end of the slot. This Figure shows that the ramps 14a and 14b are close to the wall of casing 2. Tilting the slide results in the rack 13 being disengaged from wheel 10c. The slide 14 and rack 13 have a translational and rotational movement which enables the wheel 10c to be meshed only in the useful direction of rotation of the mechanism. This arrangement also enables the slide 14 and rack 13 to tilt if the user acts on the pawl by rotating the body 1 with the push button 26 depressed. The inclined slot 9 is sufficiently long to enable such tilting following arrow G.

Operation is as follows.

Considering a starting position in FIG. 2 in which the rack 14 is at a distance from wheel 10c, the beginning of an action on the pusher 26 causes a first tilting of the rack 13 on wheel 10c and this rack 13 meshes onto wheel 10c as shown in FIG. 1. This first tilting is obtained thanks to the stiffness of the link provided between the slide 14 and the roller 16a as will be described with reference to FIG. 4. The rack 13 and the slide 14 are displaced under the action of the roller 24 turning on the spindle 25 integral with the push button 26 which acts in the inclined slot 9 following arrow F1 in FIG. 1 until it reaches its final position 19.

The slide 14 then drives wheel 10c in rotation which in turn activates wheels 10a and 10b and thereafter the ratchet 7, following the arrows shown on these elements, to tighten or loosen the screw or nut in its low torque phase.

When the tightening or loosening torque is greater, the wrench 1 operates normally. It goes without saying that the degree of rotation of wheel 10c depends on the length of the rack 13.

When the roller 24 of the pusher 26 reaches its final position 19 after completing a full rotation, the slide 14 is subjected to a second tilting (in the opposite direction to the first one) thereby causing wheel 10c to be released by the rack 13. This second tilting is caused by the pressure being released on the pusher 26 which is thereafter driven by the spring 28 causing the rotation of the slide 14 around the fixed point constituted by the roller 16a. Fully releasing the pusher 26 causes the rack 14 to reverse its movement without the rack 13 coming into contact with the wheel. During this phase, the slide 14 is constantly bearing on the spindle 17b by means of the upper edge of slot 18b and avoids meshing the rack 13 onto wheel 10c, as can be seen in FIG. 3.

After fully releasing the pusher 26, the rack takes up its starting position shown in FIG. 2.

The cycle thus described in repeated as often as required until the screw or nut is fully unscrewed or tightened.

To sum up, the push button 26 enables the finger 19 and socket A to be rapidly revolved by means of wheels and pinions when the screw or nut is free. When the screw or nut is in contact with the part to be tightened, the wrench operates like a conventional ratchet wrench. Action must thus be taken on the body 1 following arrow F4 in FIG. 7a which by means of the pawl 20 and ratchet 6 tightens the screw or nut.

FIG. 3 shows the case where the pusher 26 is held in a depressed position by the user following arrow F3 by holding the wrench 1 by its handle 36. Given that the wrench 1 is being maneuvered, the pawl 7 turns and the rack 13 has to release wheel 10c. To this end, an additional movement is provided from the slide 14 with respect to the roller 25 beyond its final position 19. It is the reaction force G between the rack and wheel which enables them to be uncoupled.

The additional movement of the roller 25 between position 19 and the bottom 9c of slot 9 enables the additional tilting of the slide to be absorbed thus releasing wheel 10c. This configuration is maintained for as long as the user keeps the pusher fully depressed, as may be seen in the Figure. The pawl 7 is thus able to turn freely without damage to the rack 13.

FIG. 4 shows a longitudinal section of the wrench 1 along plane AA in FIG. 1 where the two half-shells 2a and 2b can be seen, with the finger 19 on whose free part is fitted a socket A. Naturally, the same references designate the same elements.

This FIG. 4 more particularly shows the assembly of the ratchet 6 which turns in two bushings 5a and 5b. The hub 3 is made integral with the toothed wheel 7 by two pins 8. Toothed wheel 7 is driven in rotation as indicated previously by the wheels and pinions mounted in cascade. The ratchet 6 of the hub 3 is immobilised in one rotational direction by the pawl 20, not visible in this Figure.

This FIG. 4 shows that a washer 15b with a high friction coefficient, pushed by a spring 15a, is provided around roller 16a of spindle 17a. This stiffness generates retention on the slide 14 to enable its first tilting under the action of the pusher 26 at the moment when pressure is first put upon the pusher 26.

The finger 19 slides in the hub 3 and enables the socket A to be connected on one side or the other of the body 1, the effect of which being to change the rotational direction of the socket A. To this end, the finger 19 incorporates a groove 32 and is trapped inside the hub 3 by a pin 31 engaged in this groove. The finger 19 additionally incorporates two drill holes in which a ball 33 pushed by a spring 35 is engaged. One ball locks the finger 19 in the hub 3, the other ball locks the socket A onto the finger 19. By inverting the position of the finger 19, the screw or nut can be tightened or loosen using the wrench.

To move from the screwing function to the unscrewing function, socket A merely has to be removed and the wrench turned over, the finger 19 being moved to the other side of the wrench and the socket A inserted in that part of the finger protruding from the wrench. Marks may be made on the two faces of the casing 1 to visualize the screwing or unscrewing function of the wrench.

FIG. 5 shows a variant in which a connecting rod 51 is positioned between the push button 26 and the slide 14. This connecting rod plays the same role as the inclined slot 9 and generates the same effects on the slide 14. Identical elements have the same references. The use of the connecting rod 51 enables the friction forces which occur during the sliding of the roller 24 in slot 9 to be eliminated.

FIG. 6 shows another variant embodiment enabling a first safety mechanism to be provided to ensure the protection of the fast forward mechanism. Indeed, if the user forces the push button 26 too much when the screw is blocked, the button may be depressed without acting on the mechanism. To this end, the push button 26 is in the form of a pin hinged with respect to the casing 2 at its tip. It incorporates an internal branch 37 cooperating with the slide 14, the other branch 38 protruding from the casing 2, both branches being joined by a spring 40. Branch 37 is provided with a thing zone 39 which can bend if the load exceeds that of the pin put under constant stress. This function is deactivated when the torque is too high. The push button 26 in this case can be depressed without causing the socket to rotate.

FIGS. 7a and 7b show another variant embodiment of another safety mechanism which may be added to ensure the protection of the pawl 20.

The inattentive user may indeed use the wrench 1 over and above its confining stress. Ratchet wrenches are often designed partially to withstand these stresses and are of costly design and built using highly resistant materials.

In the case of the invention, if the pawl 20 is subjected to a limit pressure for its resistance, it moves back and the wrench turns without driving the screw. To this end, an assembly of the pawl 20 is provided on a spindle 43 integral with a part 44 sliding with respect to the casing 2, such part being held in position by a spring 45.

If the stress is too high, the sliding part 44 moves backwards compressing the spring 45 as shown in FIG. 7b. The pawl 20 thus turns freely and no longer blocks the ratchet 6 of the hub 3. To re-establish normal operation, the hub 3 must be turned in the opposite direction.

It is understood that this embodiment enables the use of ordinary inexpensive materials for the manufacture of the different parts. This second system protects screwing at high torque by the pawl. As soon as this torque has been exceeded, the pawl retracts and the wrench runs idle without driving the socket.

FIG. 8 shows a variant embodiment of another safety system in the case of the unsuitable use of the wrench 1. To this end, wheel 10c is mounted on a spindle 48 which slides in two slots 49a and 49b located in the two half-shells of the body 1. Spindle 48 is held in its drive position by a spring 50. When the rack 13 advances following arrow F, drive is performed, and when the rack moves backwards following arrow S it drives wheel 10c rearwards and disengages from wheel 10c. This embodiment enables the rack 13 to remain constantly meshed with wheel 10c.

These safety systems ensure good longevity of the wrench 1 without reducing its performances and without increasing its mass or price.

FIG. 9 shows another type of assembly of the pawl 20. To this end, the pawl is mounted able to slide in a housing provided between the two half-shells against the force of the spring 22. The trace 56 of the housing alone may be seen in the Figure. When the force applied by the user on the wrench 1 exceeds the resistance of the pawl 20, the pawl moves backwards and releases the ratchet 6 which thereafter turns freely.

FIG. 10 shows the embodiment of a wheel 51 with single inclined toothing 53 integrated into the hub 3. This structure firstly enables the fast drive of the ratchet by wheel 10a and secondly the pressure of the pawl 20 for normal screwing at high torque. The adoption of inclined toothing enables the ratchet 6 and the wheel 7 to be made in a single piece, thereby simplifying the manufacture of the wrench.

1.-14. (canceled)

15. A ratchet wrench with interchangeable sockets of the type incorporating an elongated casing formed of two half-shells in which a hub is positioned inside which slide a finger, a ratchet and an assembly of front, median and rear toothed wheels and their associated toothed pinions and a rack, wherein said wrench comprises, in addition, a slide arranged longitudinally in said casing meshing onto said rear wheel by means of said rack to drive said rear wheel in rotation and a pusher protruding from said casing linked to said slide to drive said slide in translation, means being provided to ensure a first tilting of said rack onto said rear wheel and a second tilting of this said rack to release said rear wheel.

16. Ratchet wrench according to claim 15, wherein said pusher is activated in rotation and said slide is provided with an inclined slot in which a roller of said pusher is engaged so as to transform the rotational movement of said pusher into a translational movement of said slide.

17. Ratchet wrench according to claim 15, wherein said slide is held in said casing by a first roller and a second roller, said slide being provided with a first longitudinal slot in which said first roller is engaged in order to enable only a translational movement of said slide, and a second slot in which said second roller is engaged to enable a translational and rotational movement of said slide, said rollers and said slots providing means for tilting of said rack.

18. Ratchet wrench according to claim 17, wherein said second slot has a width greater than the diameter of said second roller so as to ensure by rotation in the rear position the meshing of said slide rack on said rear toothed wheel and in the forward position the release of this said wheel.

19. Ratchet wrench according to claim 18, wherein a spring is positioned between said second roller and an edge of said second slot.

20. Ratchet wrench according to claim 15, wherein said finger is able to move in said hub between two extreme positions limited by a pin integral with said hub and sliding in a slot in said finger.

21. Ratchet wrench according to claim 20, wherein said wrench incorporates two means to lock said finger in its two extreme positions, means to lock said finger in said hub and means to lock said finger in said interchangeable sockets.

22. Ratchet wrench according to claim 15, wherein said ratchet of said hub meshes on its pawl positioned pressing on a hinge pin integral with said casing, said pawl being held in its active position by a spring.

23. Ratchet wrench according to claim 22, wherein said pawl of said hub presses on a pin integral with a sliding part connected to a spring so as to ensure the release of said pawl.

24. Ratchet wrench according to claim 15, wherein said rear wheel is mounted able to slide in said casing and is subjected to the action of a spring in order to uncouple said wheel of said rear pinion whilst continuing to drive said rack.

25. Ratchet wrench according to claim 15, wherein said pusher is in the form of a pin hinged with respect to said casing at its tip, one internal branch cooperating with said slide and the other branch protruding from said casing, said two branches being joined by a spring.

26. Ratchet wrench according to claim 24, wherein said pusher and said slide are connected together by a connecting rod.

27. Ratchet wrench according to claim 15, wherein said ratchet and said toothed wheel of said hub are represented by single toothing, such toothing being inclined so as to ensure both driving in rotation by said front wheel and immobilizing by said pawl.

28. Ratchet wrench according to claim 27, wherein said pawl is mounted able to slide on a track integrated in said body.
